(19) United States
(12) Patent Application Publication
(10) Pub. No.: US 2006/0198936 A1
(43) Pub. Date: Sep. 7, 2006

(54) Dough compositions and pretzels

(76) Inventors: Kathie Manirath, Shakopee, MN (US); Daniele Karleskind, Edina, MN (US); Carol J. Lowry, Minneapolis, MN (US)

Correspondence Address: CARGILL, INCORPORATED, LAW/24, 15407 MCGINTY ROAD WEST, WAYZATA, MN, 55391, US

(21) Appl. No.: 11/069,103

(22) Filed: Mar. 1, 2005

(51) Int. Cl. A21D 10/00

(52) U.S. Cl. 426/549

(57) ABSTRACT

There is disclosed a dough composition comprising wheat flour, water, soy protein isolate, optionally whole wheat flour, fiber, an oil or fat, a sweetener, a leavening agent and baking powder. The dough composition is suitable for producing various products including pretzels. Also disclosed is a pretzel comprising wheat flour, water, soy protein isolate, optionally whole wheat flour, water, soy protein isolate, fiber, an oil or fat, a sweetener, a leavening agent, and baking powder.

### FIELD OF DISCLOSURE

The present disclosure relates to dough compositions that are suitable for producing various products, such as pretzels, and to pretzels.

### BACKGROUND

Pretzels have been available world-wide for many years. Pretzels are available in both soft and hard forms. A typical hard pretzel formula contains flour, yeast, salt, water, malt and hydrogenated soybean oil. However, there is a desire to produce a pretzel that utilizes less carbohydrates, while still having acceptable sensory characteristics.

### SUMMARY OF THE DISCLOSURE

This disclosure relates to dough compositions comprising about 35 to about 70 weight % of wheat flour, about 10 to about 35 weight % water, greater than zero (0) to about 25 weight % soy protein isolate, 0 to about 25 weight % whole wheat flour, greater than zero (0) to about 15 weight % fiber, greater than zero (0) to about 15 weight % oil or fat, greater than zero to about 10 weight percent sweetener, about 0.01 to about 0.2 weight percent leavening agent, such as yeast, and about 0.01 to about 0.05 weight % baking powder.

The disclosure also relates in another embodiment to pretzels comprising about 35 to about 75 weight % wheat flour, greater than zero (0) to about 5 weight % water, greater than zero (0) to about 26 weight % soy protein isolate, zero (0) to about 26 weight % whole wheat flour, greater than zero (0) to about 16 weight % fiber, greater than zero (0) to about 16 weight % oil or fat, (0) to about 11 weight % sweetener, about 0.01 to about 0.3 weight % leavening agent, such as yeast, and about 0.01 to about 0.06 weight percent baking powder.

### DETAILED DESCRIPTION OF THE DISCLOSURE

This disclosure relates to dough compositions comprising about 35 to about 70 weight % of wheat flour, about 10 to about 35 weight % water, greater than zero (0) to about 25 weight % soy protein isolate, 0 to about 25 weight % whole wheat flour, greater than zero (0) to about 15 weight % fiber, greater than zero (0) to about 15 weight % oil or fat, greater than zero to about 10 weight percent sweetener, about 0.01 to about 0.2 weight percent leavening agent, such as yeast, and about 0.01 to about 0.05 weight % baking powder.

The disclosure also relates in another embodiment, to pretzels comprising about 35 to about 75 weight % wheat flour, greater than zero (0) to about 5 weight % water, greater than zero (0) to about 26 weight % soy protein isolate, zero (0) to about 26 weight % whole wheat flour, greater than zero (0) to about 16 weight % fiber, greater than zero (0) to about 16 weight % oil or fat, greater than zero (0) to about 11 weight % sweetener, about 0.01 to about 0.3 weight % leavening agent, such as yeast, and about 0.01 to about 0.06 weight percent baking powder.

The dough composition and the pretzels of the present disclosure utilize various ingredients defined as follows.

Wheat Flour

The main component of a hard pretzel formula is wheat flour. Wheat flours are available in many different varieties, each for a different use. This difference in uses is based on protein content. Generally speaking, hard wheats have higher protein and soft wheats, lower protein. Gluten, the protein of wheat, is best known for its elasticity.

Types of wheat include: hard red spring wheat (about 14% protein), durum wheat (about 15.5% protein), hard red winter wheat (about 13.5% protein), soft red winter wheat (about 11% protein), and white wheat (about 12% protein). The flour from hard red varieties is typically used in yeast-leavened bread products. Soft red wheat flours are typically used in chemically leavened products like cakes and cookies. Amber durum wheat is used exclusively for pastas while red durum is used for animal feed.

The preferred flour for hard pretzels is soft red winter wheat. Due to low protein content, the pretzel dough is easily extruded through dies and results in crispy texture. Low gluten flour will have less elasticity and more snap, resulting in desired crunch when baked. Use of higher protein flour would result in a softer texture.

Grinding and sifting wheat makes flour. The flour is typically free from bran coat and germ to an extent that the percent of ash, on a moisture free basis does not exceed more than the sum of 1/20 of the percent of protein plus 0.35. Not less than 98% passes typically through a No. 70 sieve.

Yeast/Leavening Agents

Active dry yeast is the most commonly used leavening agent in pretzels. Instant active dry yeast is the most common in batch processing. It does not require water for activation and is incorporated with other dry ingredients.

Chemical leavening is also used, although it does not provide the flavor characteristic of yeast. Examples include sodium bicarbonate, baking powder, and aluminum bicarbonate.

Sweeteners

The sweetener preferred for a pretzel is malt syrup, which adds color and flavor. Both diastatic and non-diastatic malts are used. Non-diastatic malt adds flavor and color, is used as a humectant, and extends the shelf life of the finished product. Diastatic malt may be chosen when used with active yeast for its enzyme activity. Powdered malt may also be used.

Corn syrups may also be used, and result in a lighter colored pretzel. Corn syrups are easy to handle, less expensive than malt, but not as flavorful.

Sugar is another possible sweetener option, although use of sugar produces a very hard pretzel.

Honey and dextrose may also be used, as may high intensity sweeteners.

Any sweetener, or combination of sweeteners may be used to provide the desired color, texture, flavor and tenderness.

Oils and/or Fats

Any oil or fat, or mixture thereof, may be used in producing the dough compositions and pretzels of the present disclosure. Any type of oil or fat may be used, such as animal or vegetable, or liquid or solid. Typical examples are, but not limited to, canola oil, hydrogenated soybean oil, butter, and the like. It is known that oils or fats provide tenderness, moistened mouth feel and improved pretzel structure and strength, as well as providing lubricity in the manufacturing process.

Whole Wheat Flour

A whole-wheat product ground so that not less than 90% passes through a No. 8 sieve and not less than 50% passes through a No. 20 sieve. Preferably, and as used in the Examples herein, the whole wheat product is ground so that not less than 90% passes through a No. 20 sieve.

Soy Protein Isolate

Soy protein isolate is the most highly refined soy protein product available. The soy protein isolate contains 90% protein on a moisture-free basis, in a soy product.

Fiber

Any fiber material may be used in producing the dough compositions and/or pretzels of the present disclosure. Examples of suitable fibers includes, but are not limited to, dietary fibers, soluble or insoluble types, hydrolyzed maltodextrin, inulin, resistant starch, wheat bran, and the like. It is also possible to utilize mixtures of fibers in the present disclosure.

Salt (if Desired)

Salt may be added to the pretzel dough for flavor enhancement and as a topical application for flavor and appearance. When producing a lower sodium pretzel, salt may be left out of the dough to allow some salt to be applied externally, maintaining typical pretzel appearance.

Topical Ingredients

Optional topical ingredients may be added as desired, needed or wanted for flavor and/or appearance. Examples include salt or sugar in various particle sizes, colors or shapes or natural ingredients such as sesame, flax or poppy seeds, dried fruit or vegetable (onion or garlic) bits or chocolate confections.

Preparation of Dough Compositions

The dough compositions of the present disclosure may be prepared in any conventional manner known for producing dough compositions. In the examples of the present disclosure, the dough compositions were produced in accordance with the following method.

The dry ingredients such as wheat flour, whole wheat flour, soy protein isolate, fiber, yeast, salt, and the like are weighed and placed into a Hobart mixer bowl. The ingredients are blended on speed “1” for 1 minute to preblend. When the dry ingredients are uniformly mixed, the liquid ingredients such as water, malt syrup, oil and the like are added. Blend for 1 minute on speed “1” and 3 minutes on speed “2”. Care should be taken to add enough but not too much water. The amount to add will depend on the formulation and also, moisture content of the flour, which can vary day-to-day, based on environmental conditions. The dough should be firm, cohesive and elastic. It should not stick to the sides of the mixer bowl. It must be dry and elastic enough to extrude easily, but not so dry that it exits the extruder in crumbling pieces.

Preparation of Pretzel

The dough is transferred from the Hobart mixer bowl to the extruder hopper. An extruder such as the Reading Bakery Systems single unit low-pressure extruder, Series 4, which includes cutter and pre-feed rollers is desired. Extruder, cutter, and belt speed should be calibrated to obtain a pretzel of desired weight, which is 1.8 gram per mini-twist pretzel, wet weight, in the present examples. Some production facilities have continuous mixers, which feed directly into the extruding units.

The resulting pretzel pieces travel to a cooker that is maintained at approximately 180° F. to 210° F., and contains a 1.0-1.4% caustic (sodium hydroxide) bath, into which the pretzels are dipped. The sodium hydroxide solution provides sheen, color and flavor to the pretzels. The concentration of the sodium hydroxide solution can be varied, as well as the residence time. Generally, longer exposure results in darker, more intensely flavored finished products with a harder shell. Different pretzel shapes and types require different residence times. For example pretzel rods have a pH of about 7-8, while a pretzel stick has a pH of about 6.5-7.

In the present examples of this disclosure, pretzels may be in the cooker for approximately 20 to 40 seconds, (30 seconds in the examples) with a dip time of from 4 to 15 seconds (5.5 seconds in the examples).

Subsequent to the caustic dip, the pretzels may be salted, if desired, by traveling under a steady curtain of falling salt. This step can be omitted if a low sodium pretzel is desired. The pretzels then go through an oven for 2-4 minutes at a temperature of 500-580° F. At this time the moisture content is about 10-14%. Further drying and moisture loss is accomplished in a kiln at a temperature of approximately 250° F. for about 20-25 minutes to a final moisture of 2-3%.

The following examples are presented to illustrate the present disclosure and to assist one of ordinary skill in making and using the same. The examples are not intended in any way to otherwise limit the scope of the disclosure.

### EXAMPLE 1

In this Example, a dough composition was produced as described herein by combining the following ingredients in the amounts indicated. The dough composition comprised 37.50 weight % soft red winter wheat flour, 15.00 weight % soy protein isolate, 12.50 weight % stone ground spring whole wheat flour, 5.00 weight % hydrolyzed maltodextrin, 2.08 weight % canola oil, 1.40 weight % malt syrup, 0.17 weight % yeast, 0.03 weight % baking powder, and 26.32 weight % water.

The dough composition was then utilized in accordance with the procedure described herein, to produce a pretzel. The final pretzel product is characterized as comprising 49.40 weight % soft red winter wheat flour, 19.76 weight % soy protein isolate 16.47 weight % stone ground spring whole wheat flour, 6.59 weight % hydrolyzed maltodextrim, 2.74 weight % canola oil, 1.84 weight % malt syrup, 0.22 weight % yeast, 0.04 weight % baking powder, and 2.94 weight % water.

### EXAMPLE 2

In Example 2, there is described a dough composition and pretzel product, that comprises soy protein isolate and inulin fiber. The dough composition was prepared in accordance with the method described herein. The dough composition comprised 40.15 weight % soft red winter wheat flour, 15.00 weight % soy protein isolate, 13.55 weight % stone ground spring whole wheat flour, 5.45 weight % inulin fiber, 2.08 weight % canola oil, 1.39 weight % malt syrup, 0.17 weight % yeast, 0.03 weight % baking powder, and 22.18 weight % water.

Pretzel products were then produced from the dough composition herein in accordance with the method described herein. The pretzel products are characterized as comprising 50.27 weight % soft red winter wheat flour, 18.81 weight % soy protein isolate, 16.99 weight % stone ground spring whole wheat flour, 6.83 weight % inulin fiber, 2.60 weight % canola oil, 1.75 weight % malt syrup, 0.21 weight % yeast, 0.04 weight % baking powder, and 2.50 weight % water.

### EXAMPLE 3

In Example 3 there is described a dough composition, and pretzel product, containing soy protein isolate and inulin fiber, but in the absence of whole wheat flour.

The dough composition is produced using the method described herein. The dough composition comprises 53.68 weight % soft red winter wheat flour, 15.00 weight % soy protein isolate, 5.45 weight % inulin, 2.08 weight % canola oil, 1.39 weight % malt syrup, 0.17 weight % yeast, 0.03 weight % baking powder, and 22.20 weight % water.

Pretzel products are produced in accordance with the method described herein, from the dough composition herein. The pretzel products are characterized as comprising 67.26 weight % soft red winter wheat flour, 18.81 weight % soy protein isolate, 6.83 weight % inulin, 2.60 weight % canola oil. 1.75 weight % malt syrup, 0.21 weight % yeast, 0.04 weight % baking powder, and 2.50 weight % water.

The pretzels of Examples of 1 and 2, by sensory evaluation, were found to be crispier than a pretzel having no soy and no fiber (the control pretzel); less leavened than the control pretzel; and darker color than the control pretzel. The pretzel of Example 3 is expected to have similar characteristics. Moreover, the dough compositions and pretzels having soy protein isolate and fiber, such as inulin, should provide additional nutrition.

Examples 1 and 2 were evaluated for texture using a model TA-XT2i texture analyzer available from Texture Technologies Corporation Scarsdale, N.Y. The software utilized to analyze the data is available from the manufacturer of the instrument. In evaluating the texture, a control pretzel containing no soy protein and no fiber was utilized. The value of the mean maximum force required to break the pretzel was 430.41 g for the control pretzel. For the pretzel of Example 1 the value of the mean maximum force required to break the pretzel was 883.96 g. For the pretzel of Example 2 the value for the mean maximum force required to break the pretzel was 976.32 g. It is clear from the data that the force required to break the pretzels of the present disclosure is approximately twice that of the control pretzel.

The disclosure has been described with reference to various specific and illustrative embodiments and techniques. However, one skilled in the art will recognize that many variations and modifications may be made while remaining within the sprit and scope of the disclosure and the claims.

What is claimed is:

1. A dough composition comprising:
a) from about 35 to about 70 weight % wheat flour;
b) from about 10 to about 35 weight % water;
c) from greater than zero (0) to about 25 weight % soy protein isolate;
d) from zero (0) to about 25 weight % whole wheat flour;
e) from greater than zero (0) to about 15 weight % fiber;
f) from greater than zero (0) to about 15 weight % of a component selected from the group consisting of an oil and a fat;
g) from greater than zero (0) to about 10 weight % sweetener;
h) from about 0.01 to about 0.2 weight % leavening agent; and
i) from about 0.01 to about 0.05 weight % baking powder.

2. The dough composition according to claim 1 wherein the fiber is selected from the group consisting of inulin, a dietary fiber, hydrolyzed maltodextrin, a resistant starch, wheat bran, and mixtures thereof.

3. The dough composition according to claim 2 wherein the fiber is inulin.

4. The dough composition according to claim 1 wherein the component is an oil.

5. The dough composition according to claim 4 wherein the oil is canola oil.

6. The dough composition according to claim 1 wherein the sweetener is malt syrup.

7. The dough composition according to claim 1 wherein the leavening agent is yeast.

8. The dough composition according to claim 1 wherein the fiber is inulin, the component is an oil that is canola oil, the sweetener is malt syrup and the leavening agent is yeast.

9. A pretzel comprising:
a) from about 35 to about 75 weight % of wheat flour;
b) from greater than zero (0) to about 5 weight % water;
c) from greater than zero (0) to about 26 weight % soy protein isolate;
d) from zero (0) to about 26 weight % whole wheat flour;
e) from greater than zero (0) to about 16 weight % fiber;
f) from greater than zero (0) to about 11 weight % sweetener;
g) from about 0.01 to about 0.3 weight % leavening agent;
h) from about 0.01 to about 0.06 weight % baking powder; and
i) from greater than zero (0) to about 16 weight % of a component selected from the group consisting of an oil and a fat.

10. The pretzel according to claim 9 wherein the fiber is selected from the group consisting of inulin, a dietary fiber, hydrolyzed maltodextrin, a resistant starch, wheat bran, and mixtures thereof.

11. The pretzel according to claim 10 where the fiber is inulin.

12. The pretzel according to claim 9 wherein the component is an oil.

13. The pretzel according to claim 12 wherein the oil is canola oil.

14. The pretzel according to claim 9 wherein the sweetener is malt syrup.

15. The pretzel according to claim 9 wherein the leavening agent is yeast.

16. The pretzel according to claim 9 wherein the fiber is inulin, the component is an oil that is canola oil, the sweetener is malt syrup, and the leavening agent is yeast.
